(19) United States
(12) Patent Application Publication
(10) Pub. No.: US 2008/0067899 A1
(43) Pub. Date: Mar. 20, 2008

(54) BLDC motor

(76) Inventor: Gun Son, Yangsan-si (KR)

Correspondence Address: Song K. Jung;MCKENNA LONG & ALDRIDGE LLP, 1900 K Street, NW, Washington, DC, 20006, US

(21) Appl. No.: 11/650,993

(22) Filed: Jan. 9, 2007

(30) Foreign Application Priority Data
Sep. 18, 2006 (KR) 10-2006-0089952
Oct. 12, 2006 (KR) 10-2006-0099174

(51) Int. Cl. H02K 7/00; H02K 5/00; G11B 17/08

(52) U.S. Cl. 310/67 R; 310/156.26; 310/91; 360/98.08

(57) ABSTRACT

A BLDC motor includes a rotor having a permanent magnet attached to an inner circumferential surface thereof, a stator that forms a magnetic field to rotate the rotor and a bracket provided in a lower portion of the rotor to support the stator, where the bracket includes a strength reinforcement part. The BLDC motor has an improved structure which may enhance strength of the bracket. The BLDC motor may prevent moisture penetration.

This application claims the benefit of the Patent Korean Application Nos. 10-2006-0089952, filed on Sep. 18, 2006 and 10-2006-0099174, filed on Oct. 12, 2006, which are hereby incorporated by reference as if fully set forth herein.

### BACKGROUND OF THE INVENTION

1. Field of the Invention

The present invention relates to a motor, and in particular, to a BLDC motor having an improved structure that enhances strength thereof and prevents moisture penetration.

2. Discussion of the Related Art

In general, a motor is a device that converts electrical energy into mechanical energy that may generate rotational power. The motor is broadly categorized into a DC motor (Direct Current motor) and an AC motor (Alternating Current motor) based on the electrical input power applied thereto. A BLDC motor (Brushless DC motor) is a kind of DC motor that may be used to drive an electric appliance.

Generally, the BLDC motor includes a stator having 2-phase, 3-phase or 4-phase coil and a rotor including a permanent magnet. Owing to the development of permanent magnets, the BLDC motor, which does not have a commutator has been adapted as a motor for adjustable speed drive, and especially, as a servo drive. Its usage has been diverse extending from households to industries and etc.

Specifically, a stator of the BLDC motor includes a stator wire for generating a rotation field and a stator core for forming a magnetic flux path in which a magnetic flux flows smoothly. A rotor of the BLDC motor includes a rotor core and a permanent magnet.

According to an operational principle of the BLDC motor, once a rotation field is formed by the stator wire of, e.g., a 3-phase wire, the magnetic flux of the rotation field acts with the magnetic flux of the permanent magnet to rotate the rotor in a predetermined direction, such that torque may be generated.

Referring to an outer rotor type BLDC motor of FIGS. 1 to 3, a structure of a conventional BLDC motor will be described.

FIG. 1 is a perspective view illustrating an exterior of a conventional BLDC motor, FIG. 2 is a longitudinal sectional view of the conventional BLDC motor, and FIG. 3 is an enlarged view of FIG. 2.

The conventional BLDC motor includes a stator 8, an upper bracket 2, a driving shaft 1, a lower bracket 3 and a fastening part 4. The stator 8 has a winding coil 9 that is used to form a magnetic field. The upper bracket 2 is provided over the stator 8 and can be rotated by an interaction between a permanent magnet 7 and the magnetic field formed at the stator 8. Here, the permanent magnet 7 is attached to an inner surface of the upper bracket 2. The driving shaft 1 is connected to the upper bracket 2 as one body so as to rotate with the upper bracket 2. The lower bracket 3 together with the upper bracket 2 sealingly holds the stator 8. The fastening part 4 fixedly fastens the stator 8 to the lower bracket 3. Here, a bearing (not shown) may be applied to an upper and lower portion of the driving shaft 1, which may support the driving shaft 1.

As shown in FIG. 2, the conventional lower bracket 3 may be made of aluminum for easy molding and plural fastening holes 5 are formed on a bracket base to fasten the fastening part thereto. Thus, in the case that the stator 8 is fastened to the lower bracket 3 by the fastening part 4, some portion of the fastening part 4 projects from the lower bracket base. Because a bottom of the lower bracket 3 may be uneven due to the commonly projected fastening parts 4, a circumference of the bottom is more projected than the desired projection of the fastening parts 4 to mount a product conveniently.

The upper bracket 2 attaches with the lower bracket 3 as closely as possible to protect the winding coil 9 held therein from water. However, since the upper bracket 2 should rotate about the driving shaft 1, the upper bracket 2 should maintain some distance from the lower bracket 3 in order to prevent friction. As shown in FIG. 3, according to the conventional BLDC motor, the upper bracket 2 maintains a distance from the lower bracket 3 horizontally as a tolerance limit (a) and vertically as a tolerance limit (b).

Thus, the fastening part 4 and the circumference of the lower bracket bottom of the conventional BLDC motor are projected sufficiently downwards to lengthen a shaft direction length of the motor. Thereby, there is a disadvantage of having a limitation when trying to mount the conventional BLDC motor in a small space.

Furthermore, when the conventional BLDC motor stands vertically, water penetrates between the upper bracket 2 and the lower bracket 3 and contacts with the winding coil 9 and a circuit substrate (not shown) to cause a malfunction like a short circuit. Thereby, there is a concern of a fire.

### SUMMARY

An object of the present invention is to provide a BLDC motor having an improved structure that may enhance strength of a bracket

Another object of the present invention is to provide a BLDC motor that may prevent moisture penetration.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a BLDC motor includes a rotor having a permanent magnet attached to an inner circumferential surface thereof; a stator that forms a magnetic field to rotate the rotor; and a bracket provided at a lower portion of the rotor to support the stator, where the bracket includes a strength reinforcement part.

The BLDC motor further may include a fastening part that fixedly fastens the stator to the bracket.

A concave part recessed inwardly is formed at a base of the bracket and an end of the fastening part is positioned in the concave part.

The height of concave part may be higher than the height in which the end of the fastening part projects from the base.

Preferably, the concave part has a flat portion larger than a cross section of the fastening part.

Here, a plurality of concave parts may be provided and three concave parts may be formed at portions of the bracket to divide the bracket into three equal parts, and in a perpendicular direction with respect to a center of the bracket.

The fastening part is positioned on some of the plural concave parts.

Here, preferably the concave part is formed on the same circumference with respect to the center of the bracket.

The concave part is formed in a ring-shape and the bracket is made of iron plate.

Preferably, the bracket comprises a flat section and the flat section formed at an outer end portion of the bracket, is adjacent to a lower end of the rotor, and bent in two places.

The bracket further comprises a flat section adjacent to a lower end of the rotor, and bent in two places. A recess is formed at the flat section or a base of the bracket. The recess may be further formed along a circumference of the bracket in a ring shape.

A plurality of holes may be formed within the recess. Preferably, the rotor and the bracket are spaced apart a predetermined distance from each other.

The BLDC motor according to various embodiments of the present invention has following advantageous effects.

First, the BLDC motor may be installed in a smaller space, because the BLDC motor has the recess part formed on the bracket for the fastening part so that it will not project out after the fastening part is fastened to the stator.

Second, the strength of the lower bracket provided in the BLDC motor according to various embodiments of the present invention may be enhanced, because the bottom surface of the bracket has a curved section.

Third, the material cost of the BLDC motor may be reduced, because the bracket is made of iron.

Fourth, accidents such as fires and the like may be prevented because moisture is prevented from penetrating into the motor to cause a short circuit.

Finally, the strength of the bracket may be enhanced because the recess functions like a rib.

It is to be understood that both the foregoing general description and the following detailed description to follow are exemplary and explanatory and should not be construed as limiting the scope of the claims.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a rear view illustrating an exterior of a conventional BLDC motor;

FIG. 2 is a sectional view longitudinally illustrating a structure of the conventional BLDC motor;

FIG. 3 is a sectional view longitudinally illustrating a lower bracket of a conventional outer rotor type motor;

FIG. 4 is a perspective view illustrating an exterior of a BLDC motor according to a first embodiment of the present invention;

FIG. 5 is a perspective view illustrating an exterior of a BLDC motor according to a second embodiment of the present invention;

FIG. 6 is a sectional view longitudinally illustrating a structure of the BLDC motor according to the second embodiment of the present invention;

FIG. 7 is a sectional view longitudinally illustrating a lower bracket of the BLDC motor according to a third embodiment of the present invention; and

FIG. 8 is a sectional view longitudinally illustrating a lower bracket of a BLDC motor according to a fourth embodiment of the present invention.

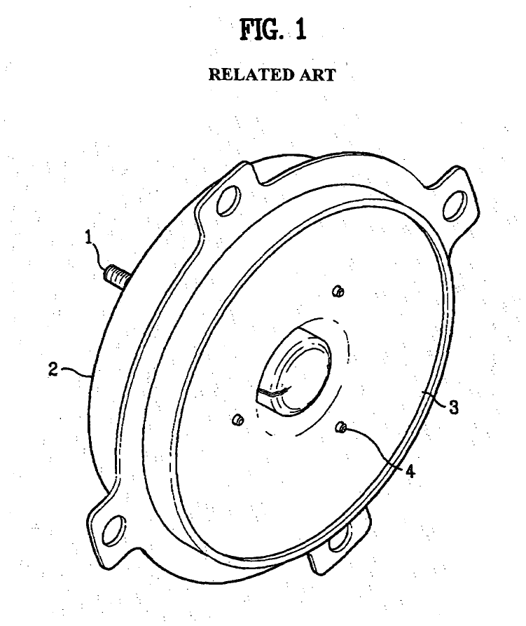

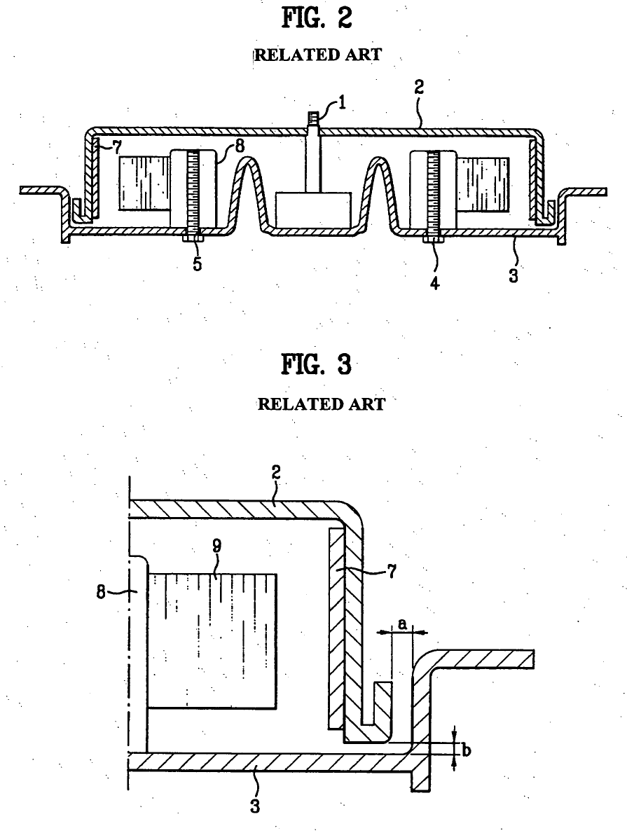

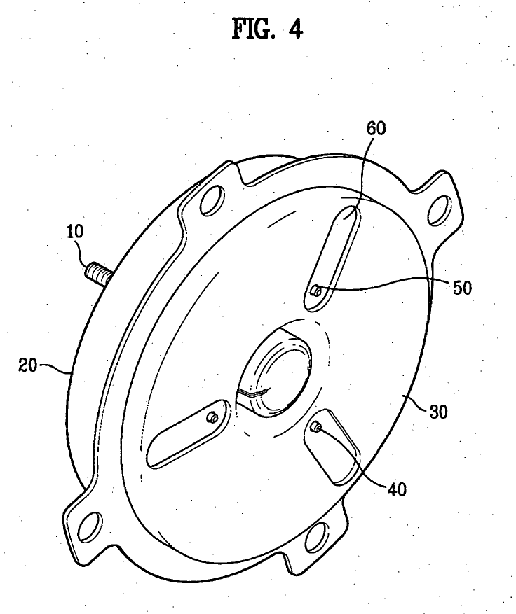

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

Referring to FIGS. 4 to 6, a BLDC motor according to a first embodiment of the present invention will be described.

The BLDC motor includes a stator 80, an upper bracket 20, a driving shaft 10, a lower bracket 30 and a fastening part 40. The stator 80 may generate a magnetic field. The upper bracket 20 interacts with the stator 80 so as to rotate. The driving shaft 10 is connected to the upper bracket 20 as one body so as to allow the upper bracket 20 to rotate about the rotational axis of the driving shaft 10. The lower bracket 30 defines an exterior together with the upper bracket 20 and holds the stator 80 therein. The fastening part 40 fastens the stator 80 to the lower bracket 30.

The lower bracket 30 has a concave part 60 at a location where the stator 80 is fastened. The concave part 60 has a fastening hole 50 formed thereon. Here, the concave part 60 is recessed inwardly. Thereby, the fastening part 40 is not projected from a base of the lower bracket 30 when the fastening part 40 is fastened to the lower bracket 30. The shape of the concave part 60 may be a square, oval and the like and almost all shapes are allowable. The concave part 60 may have a flat section larger than the cross section of the fastening part 40 to maintain the similar fastening strength as the fastening strength of the fastening part 40 fastened to a flat base of the lower bracket 30. Preferably, the fastening hole 50 is formed at the flat section. Also, the strength of the lower bracket 30 may be enhanced than the case in which the base of the lower bracket 30 is flat.

Preferably, the lower bracket 30 is made of iron plate to reinforce its strength. Also, the upper bracket 20 may be made of iron plate. Because aluminum is better than iron in malleability and ductility, when iron having high strength is used, it is preferred that the lower bracket 30 is fabricated in casting. Alternatively, only the concave part 60 may be made using sheet metal. Also, iron costs less than aluminum, and thereby reducing using the cost of materials.

Because more than two fastening parts 40 are provided to maintain fastening strength, it is preferred that more than two concave parts 60 are formed. More concave parts 60 may be formed than the fastening parts 40 to reinforce the strength of the lower bracket 30. This embodiment presents for convenience's sake that the fastening parts 40 and the concave parts 60 are positioned at portions which trisect the lower bracket 30.

It is preferred that the concave part 60 is positioned on a flat section of the lower bracket 30. If the concave part 60 is positioned on a curved portion of the lower bracket 30, larger force may be needed to form the concave part 60 due to the strength of iron and the iron may bend undesirably due to general quality of metal.

Although this embodiment illustrates that the fastening part 40 is a bolt fastened to the fastening hole 50 of the lower bracket 30, it is more preferred that a nut is screwed on an outer surface of the lower bracket 30. Also, the fastening part 40 is not limited that disclosed in the embodiment.

A notable technical feature of the embodiment is that the concave part 60 of the lower bracket 30 has a predetermined height (h) from a bottom surface of the lower bracket 30. Here, the predetermined height (h) may be higher than the height in which the fastening part 40 is projected from the base of the lower bracket 30. This is to prevent the fastening part 40 from projecting to make a height of the motor higher.

Preferably, the height of the fastening part 40, that fastens the stator 80 to the lower bracket 30, is the same as that of conventional fastening part according to the prior art. That is because the projection height of the fastening part 40 is similar to that of prior art to maintain the fastening strength between the stator 80 and the lower bracket 30 at a similar level, compared to the prior art.

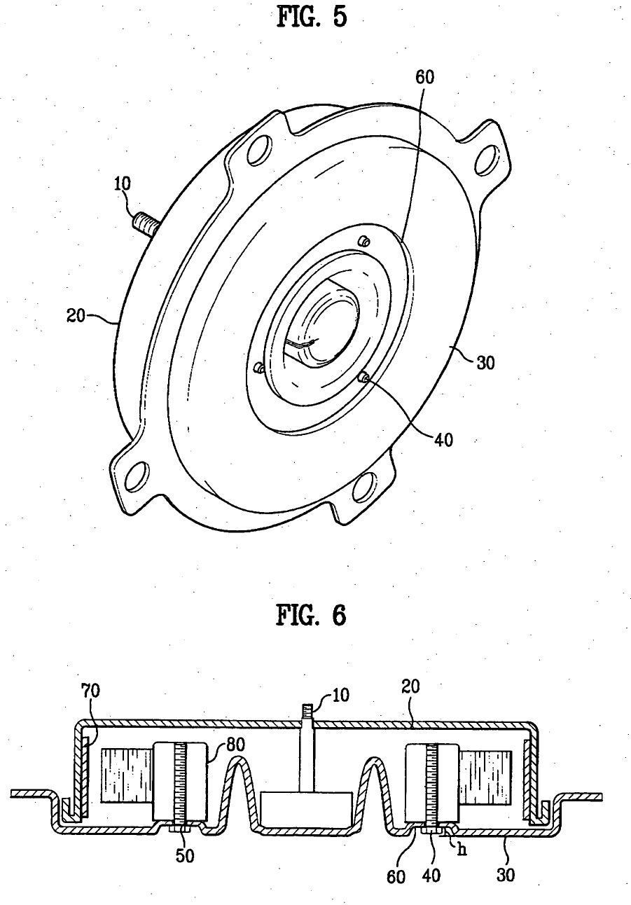

Referring to FIGS. 5 and 6, a second embodiment of the BLDC motor according to the present invention will be described.

A concave part 60 of the BLDC motor according to the second embodiment is formed in a ring shape with respect to a center of the lower bracket 30. Alternatively, a plurality of concave parts 60 may be formed on the same circumference with respect to the lower bracket 30. Preferably, the width of the concave part 60 is larger than the cross section of the fastening part 40. The cross section of the lower bracket 30 may be similar to that shown in FIG. 6, though the width of the concave part 60 may vary.

These kinds of structures may enhance the strength of the lower bracket 30 more than the structure described in the former embodiment. If the concave part 60 is circular, the lower bracket 30 may be fabricated simply in comparison with the case when the concave part 60 is formed each position where the fastening part 40 is fastened.

Thus, the BLDC motor according to the second embodiment of the present invention may reduce the height of the motor, because the concave part 60 is formed on the lower bracket 30.

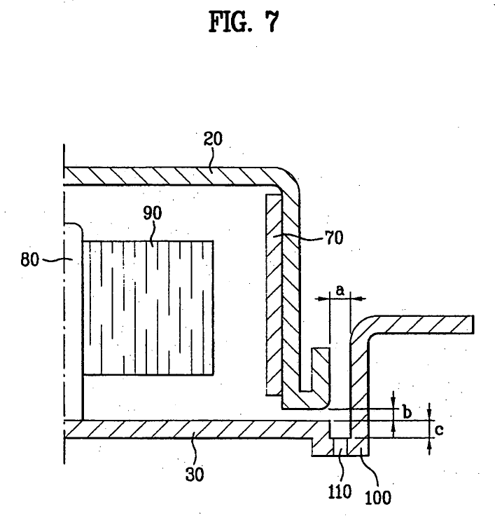

Referring to FIG. 7, a third embodiment of the present invention will be described.

FIG. 7 partially illustrates a front view of a lower bracket cut away from a BLDC motor according to an embodiment of the present invention.

The lower bracket 30 of the BLDC motor according to a third embodiment of the present invention is the same as that of prior art in its material and function. But, the lower bracket 30 of the third embodiment includes a recess 100 which could store water to prevent water from penetrating though the motor in which electricity flows.

The recess 100 is provided on an outer portion of the lower bracket 30 to which an upper bracket 20 comes near. Also, the recess 100 is formed on a lower end of the lower bracket 30 along a bent perpendicular surface of the lower bracket 30, that the water drawn into the motor flows to or along the bent surface of the lower bracket 30. The water of the upper bracket 20 flows along an outer circumferential surface of the upper bracket 20 and is held at a lower end of the outer surface bent upwardly in a U shape.

The recess 100 may be needed if the motor standing vertically. It is preferred that the recess 100 is recessed downwardly. The depth of the recess 100 may be as deep as (c) shown in FIG. 7 and the function of the recess 100 is to enhance the strength of the lower bracket 30, which is the same as that of a rib.

Since the upper bracket 20 and the lower bracket 30 are formed in a circular shape, it is preferred that the recess 100 is formed in a ring shape and also that a plurality of recesses 100 are formed on the same circumference to prevent the water from flowing into the motor.

Although the recess 100 has a predetermined depth and the plural recesses 100 are provided, the water may overflow out of an upper end of the recess into the motor when the water is continuously drawn. Thus, a plurality of water drain holes 110 may be formed at a bottom surface of the recess 100 to efficiently drain the water.

A rib may be formed at an inner surface of the lower bracket 30, where the position of the rib is inner than a boundary with the upper bracket 20, and perpendicular to the base of the lower bracket 30. Here, the rib may not interfere with the magnetic field formed among the permanent magnet 70, the stator 80 and the coil 90. Alternatively, the technical feature of the third embodiment may be included in the first and second embodiment.

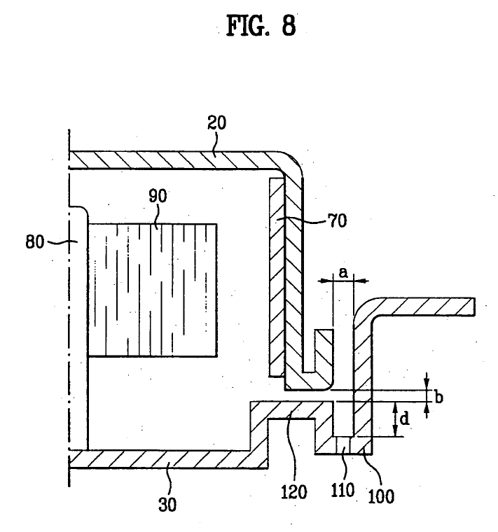

Referring to FIG. 8, a fourth embodiment of the BLDC motor according to the present invention will be described.

To prepare in the case that a lot of water drastically gets drawn into the lower bracket 30 and to reinforce the strength of the lower bracket 30, in this embodiment, an outer end of the lower bracket 30 is bent in two places to form a flat section 120 and a recess 100 having a predetermined depth on the flat section 120 so that the recess 100 may be deeper than that of the recess 100 described in the third embodiment.

The lower bracket 30 supports the stator 80 which forms a magnetic field that interacts with the upper bracket 20 to rotate the upper bracket 20. That is, the lower bracket 30 receives a horizontal direction power from the stator 80. Since the rib formed on the end of the lower bracket 30 is fastened to an electric device to receive vibration generated in the device, the lower bracket 30 does not become twisted until after a long time of usage. Also, if the recess 100 is two-stepped to heighten a standard surface of the recess 100, the depth of the recess 100 is as deep as (d), which is deeper than (c). Thus, the amount of water that can be held in the recess 100 is increased because the recess 100 is recessed deeper than the recess 100 of the former embodiment. Moreover, as described in the third embodiment, a water drain hole 110 may be formed and the technical feature of the drain holes 110 may be combined with technical features of the first and second embodiments.

Therefore, according to the embodiment of the present invention, the strength of the bracket may be enhanced and water may be prevented from flowing into the motor.

It will be apparent to those skilled in the art that various modifications and variations can be made without departing from the spirit or scope of the invention. Thus, it is intended that the claims cover the various modifications and variations provided that they come within the scope of the appended claims and their equivalents.

What is claimed is:

1. A BLDC motor comprising:
a rotor having a permanent magnet attached to an inner circumferential surface thereof;
a stator that forms a magnetic field to rotate the rotor; and
a bracket provided at a lower portion of the rotor to support the stator, wherein the bracket includes a strength reinforcement part.

2. The BLDC motor of claim 1, further comprising a fastening part that fixedly fastens the stator to the bracket.

3. The BLDC motor of claim 2, wherein a concave part recessed inwardly is formed at a base of the bracket and an end of the fastening part is positioned in the concave part.

4. The BLDC motor of claim 3, wherein the height of concave part is higher than the height in which the end of the fastening part projects from the base.

5. The BLDC motor of claim 4, wherein the concave part has a flat portion larger than a cross-section of the fastening part.

6. The BLDC motor of claim 3, wherein a plurality of concave parts are provided.

7. The BLDC motor of claim 6, wherein three concave parts are formed at portions of the bracket to divide the bracket into three equal parts, and in a perpendicular direction with respect to a center of the bracket.

8. The BLDC motor of claim 6, wherein the fastening part are positioned on some of the plural concave parts.

9. The BLDC motor of claim 6, wherein the concave parts are formed on the same circumference with respect to the center of the bracket.

10. The BLDC motor of claim 3, wherein the concave part is formed in a ring-shape.

11. The BLDC motor of claim 3, wherein the bracket is made of iron plate.

12. The BLDC motor of claim 3, wherein the bracket comprises a flat section and the flat section 11 formed at an outer end portion of the bracket, is adjacent to a lower end of the rotor, and bent in two places.

13. The BLDC motor of claim 1, wherein the bracket further comprises a flat section adjacent to a lower end of the rotor, and bent in two places.

14. The BLDC motor of claim 13, wherein a recess is formed at the flat section or a base of the bracket.

15. The BLDC motor of claim 14, wherein the recess is formed along a circumference of the bracket in a ring shape.

16. The BLDC motor of claim 14, wherein a plurality of holes are formed within the recess.

17. The BLDC motor of claim 13, wherein the rotor and the bracket are spaced apart a predetermined distance from each other.
